(19) United States
(12) Patent Application Publication
(10) Pub. No.: US 2007/0007273 A1
(43) Pub. Date: Jan. 11, 2007

(54) Multi-tier chocolate fountain apparatus

(76) Inventor: Michel Esnault, Lasalle (CA)

Correspondence Address: Franz BONSANG;c/o PROTECTIONS EQUINOX INT'L INC., Suite 224, 4480, Cote-de-Liesse, Montreal, QC, H4N 2R1, CA

(21) Appl. No.: 11/520,576

(22) Filed: Sep. 14, 2006

Related U.S. Application Data
(63) Continuation-in-part of application No. 10/942,946, filed on Sep. 17, 2004.

(30) Foreign Application Priority Data
Sep. 16, 2005 (GB) 0518970.9

(51) Int. Cl. F27D 11/00

(52) U.S. Cl. 219/429

(57) ABSTRACT

A fountain apparatus for use with a flowable food media includes a recipient for receiving the food media therein, an elongated post and a conveyor mechanism. The post defines first and second ends thereof and a passageway extending longitudinally there between. The first end mounts on the recipient so that the passageway is in fluid communication therewith. The post has a plurality of post longitudinal sections that extend in an end-to-end relationship relative to one another and releasably and abuttingly support one another. The conveyor mechanism operatively connects to the post for conveying the food media from the first end toward the second end through the passageway. At least one tier mounts on one of the post sections.

### CROSS REFERENCE TO RELATED APPLICATIONS

This application is a continuation-in-part (C.I.P.) of co-pending patent application Ser. No. 10/942,946 filed on Sep. 17, 2004, now abandoned.

### FIELD OF THE INVENTION

The present invention relates to a multi-tier flowable food fountain and methods, and is more particularly concerned with a sanitary multi-tier food fountain apparatus comprising components easily mounting onto and dismounting from each other without screws or the like.

### BACKGROUND OF THE INVENTION

It is well known in the art to have various types of fountains accommodating fluids. More specifically, fountains for eatable viscous fluids such as melted chocolate have been commercialized since approximately 1995. A typical chocolate fountain where the melted chocolate goes up from a heated bowl via a hidden conveyor screw to then fall in a cascade, curtain-like or waterfall manner back into the heated bowl offers innovative, ornamental and functional characteristics for banquets and the like. For example, a user can after putting a fruit on a fork, bring the fork under the cascading fluid chocolate falling in-between the stages of the fountain for chocolate enrobing before consumption. The former fountains on the market presented tiered-trays, platforms, stages, skirts, landings or brims maintained in place by nuts and bolts or other method using conventional attachment means.

Other apparatuses found in the art include U.S. Pat. No. 3,451,622 issued to Forney on Jun. 24, 1969 uses two tubes of different diameters. U.S. Pat. No. 3,691,787 issued to Kaufmann on Sep. 19, 1972 presents a beverage fountain where the intermediate receptacle is supported on a shoulder at the upper end of the sleeve, whilst the intermediate receptacle supports the upper receptacle. Similarly, U.S. Pat. No. 3,713,583 issued to Gruber on Jan. 30, 1973 has a second beverage bowl mounted directly on the cover post. U.S. Pat. No. 3,722,816 issued to Stewart et al. on Mar. 27, 1973 discloses a retractable fountain assembly using telescoping conduit sections. U.S. Pat. No. 4,026,417 issued on May 31, 1977 to Streim et al. discloses a display stand where each combination of platform and sleeve rests on a guard plate. U.S. Pat. No. 4,099,627 issued to Strada on Jul. 11, 1978 presents a arrangement for displaying articles where the plurality of elements are stackable one onto another, i.e. where the abutment shoulder is part of the element itself. In another aspect of the invention, a plate is fixed on the shaft by a cotter pin. U.S. Pat. No. 4,678,089 issued to Lang on Jul. 7, 1987 presents a display stand where the goods carriers are held in place using a wedge engagement sleeve. Successive sections of the carrier column are further fitted together telescopically. U.S. Pat. No. 4,847,461 issued to Gilmore on Jul. 11, 1989 shows a stackable plate arrangement for microwave dishes where a plurality of support units is used. Similarly, a plurality of support posts are used in U.S. Pat. No. 4,964,520 issued to Kilmartin, III on Oct. 23, 1990. U.S. Pat. No. 6,123,206 issued to Zaremba on Sep. 26, 2000 presents a removable display attachment with wedgelike retainers for vertical rigid cylindrical supports. O-rings and other types of wedge retainers are shown. U.S. Pat. No. 6,681,684 issued to Chen on Jan. 27, 2004 provides for tapered sections interengaging each other. U.S. Pat. No. 7,021,556 issued to Muir et al. on Apr. 4, 2006 provides for a fountain for heating and distributing fluidic material manufactured using various processes and materials so that the fountain is more easily cleaned and sanitized, has improved performance, and is easier to assemble.

All above arrangements include one or more technical problems related with the amount of pieces or elements connectable to each other at interfaces, and the fact that all these interfaces are complex. Consequently, all pieces, when doable, need to be disassembled from each other for cleaning which could be time consuming. Furthermore, the interfaces, especially when not easy or even impossible to disassemble, are difficult to clean and prone to sanitary concerns over time, when the chocolate (or other flowable food media) reaches interstices or gaps at the interfaces.

In existing chocolate fountains, the attachment of the cylinder (or post) containing the auger (or worm screw) to the main recipient via a plurality of discrete pins or the like is not convenient especially when the recipient is filled with chocolate that totally covers the pins. In such a case, to properly align the cylinder with the pins, the installer needs to find the pins using his/her fingers dipped into the chocolate.

Also, when the cylinder gets relatively long, it becomes a problem to have a cylinder-auger combination with both components perfectly straight such that they do not interfere with one another when the auger rotates within the cylinder while having a relatively tight fit there between.

Accordingly, there is a need for an improved multistage or multi-tier flowable food fountain.

### SUMMARY OF THE INVENTION

It is therefore a general object of the present invention to provide an improved multi-tier flowable food fountain apparatus that solves the above-noted technical problems.

Accordingly, an advantage of the present invention is that the multi-tier fountain apparatus provides for an enjoyable and self-operating way of entertaining guests.

Another advantage of the present invention is that the multi-tier fountain apparatus provides for simple, rapid, sanitary clean and efficient assembly and disassembly of the apparatus, especially considering the positioning and withdrawal of the staged tiers which do not require any external attachment means, using post steps (flanges) of successive diameters. In a second embodiment, the tiers permanently attached to a corresponding central post or cylinder section. In a third embodiment, the tiers are releasably mounted on the post at corresponding intersections of adjacent post sections.

A further advantage of the present invention is that the multi-tier fountain apparatus provides for an easy manufacturing of the apparatus, especially considering the central post or sleeve that is free of welds and attachment holes, reducing the quantity of components of the apparatus and the manufacturing costs in mass production.

Still another advantage of the present invention is that the multi-tier fountain apparatus provides for materials that can be safely used with food products and within the guidelines of appropriate safety standards and food regulations.

Another advantage of the present invention is that the multi-tier fountain apparatus provides for use of pieces of un-melted chocolate mixed with fluid chocolate during operation and a heating element enabling melting chocolate and keeping the melted chocolate at an appropriate temperature range for proper operation.

Still a further advantage of the present invention is that the multi-tier fountain apparatus provides for other fluid with a certain viscosity to be used in a cascade manner.

Still another advantage of the present invention is that the multi-tier fountain apparatus provides for a heating chamber not in direct contact with the walls of the stand.

A further advantage of the present invention is that the multi-tier fountain apparatus provides for a driving shaft that can be easily demounted from the recipient since it does not include any pin or the like that protrudes radially there from. In one embodiment, a similar attachment mechanism can be used to secure adjacent sections of the worm screw to one another to provide a length adjustable and/or an articulated worm screw.

Another advantage of the present invention is that the multi-tier fountain apparatus provides for a curtain-fall of warm melted chocolate under which a fruit or the like can be brought for coating.

Yet another advantage of the present invention is that the multi-tier fountain apparatus provides for an easy releasable securing means of the post to recipient, typically including a lock that prevents the rotation of the post relative to the recipient when mounted thereon. The same securing means can be used between adjacent post sections to provide a length adjustable and/or an easily mountable post.

According to an aspect of the present invention, there is provided a fountain apparatus for use with a flowable food media, said apparatus comprises: a recipient for selectively receiving the flowable food media therein; an elongated post defining generally opposed first and second longitudinal ends and a passageway extending longitudinally therebetween, said first longitudinal end mounting on said recipient so that said passageway is in fluid communication therewith, said post having a plurality of post longitudinal sections extending in an end-to-end relationship relative to one another and releasably and abuttingly supporting one another; a conveyor mechanism operatively connecting to said post for conveying the flowable food media from said first longitudinal end toward said second longitudinal end through said passageway; at least one tier mounted on one of said post sections.

In one embodiment, at least one of said post sections permanently supports a tier thereon.

In one embodiment, at least one of said post sections includes a ring connected thereto for abuttingly supporting a tier thereon.

In one embodiment, the apparatus further includes a post securing means removably connecting adjacent said post sections to one another.

Typically, the post securing means allow said tier to be abuttingly supported thereon.

According to another aspect of the present invention, there is provided a fountain apparatus for use with a flowable food media, said apparatus comprises: a recipient for selectively receiving the flowable food media therein; an elongated post defining generally opposed first and second longitudinal ends and a passageway extending longitudinally therebetween; a conveyor mechanism operatively connecting to said post for conveying the flowable food media from said first longitudinal end toward said second longitudinal end through said passageway; a post securing means for releasably mounting said first longitudinal end on said recipient, said post securing means including a post mounting base having a plurality of standoffs connected to said recipient, said standoffs being spaced apart form one another and defining inlet openings therebetween to allow said passageway to be in fluid communication with said recipient, said post mounting base including a flange interconnecting said standoffs to one another, said post mounting base having a shoulder to abuttingly support said post thereon along with said flange being inwardly extendable within said passageway to abuttingly support said post thereagainst.

In one embodiment, the post has at least one shoulder extending radially and outwardly therefrom for abuttingly supporting a tier thereon.

In one embodiment, the shoulder defines at least two shoulder portions extending radially, outwardly and partially circumferentially from said post for abuttingly supporting a tier thereon.

Typically, the tier defines a platform with an opening extending therethrough and defining a platform inner edge, said opening being configured and sized for being engageable by at least a longitudinal section of said post extending from said second longitudinal end to said at least one shoulder, at least a circumferential portion of said platform inner edge being in abutment contact with said shoulder.

Typically, the post defines a plurality of post longitudinal sections, said post sections extending between said first and second longitudinal ends in an end-to-end relationship relative to one another, each said post sections having a respective outer diameter, respective said outer diameters gradually increasing from said second longitudinal end toward said first longitudinal end so that said post sections form a plurality of shoulders at interfaces thereof for abuttingly supporting a respective tier thereon.

In one embodiment, the plurality of platforms are substantially equally spaced from one another along said post.

Typically, each of said tiers defines a platform with an opening extending therethrough and defining a platform inner edge, said opening being configured and sized for being engageable by at least one of said post longitudinal sections extending from said second longitudinal end to a respective said shoulders, at least a circumferential portion of said platform inner edge being in abutment contact with respective said shoulder.

Typically, each platform has a truncated conical shape tapering radially outwardly in a direction going from said second longitudinal end toward said first longitudinal end.

Typically, the recipient defines a concave inner surface thereof, said post mounting base extending outwardly from a location adjacent an apex region of said inner surface.

In one embodiment, the shoulder extends all along said flange.

In one embodiment, the conveyor mechanism includes a worm screw removably connected to a driving shaft via a worm screw connecting means, said driving shaft sealably extending through an opening of said recipient, said worm screw axially mounting into said passageway for conveying the flowable food media from said first longitudinal end toward said second longitudinal end.

In one embodiment, the worm screw has a central shaft with a shaft first longitudinal end connectable to said driving shaft, said worm screw connecting means including an axial bore of said shaft first end with a pin diametrically extending therethrough, said pin removably engaging a corresponding diametrically extending slot of said driving shaft.

Typically, the worm screw has a central shaft with a shaft first longitudinal end connected to said driving shaft through a shaft extension, said worm screw connecting means including an axial bore of said shaft extension with a pin diametrically extending therethrough, said pin removably engaging a corresponding diametrically extending slot of said driving shaft.

In one embodiment, the apparatus further comprises a post extension axially extending said post first longitudinal end, said post extension being connectable to said recipient via said post securing means, said post extension having an extension passageway extending longitudinally therethrough, said extension passageway being substantially an extension of said passageway for operative connection with said conveyor mechanism to convey the flowable food media therethrough between said recipient and said passageway.

In one embodiment, the recipient defines a recipient outer edge, said recipient including a recipient guard mounting on said recipient adjacent said recipient outer edge.

Typically, the recipient guard has a guard opening extending therethrough, said guard opening defining a guard inner edge removably connectable to said recipient outer edge.

Typically, the guard opening is sized to enable said guard to be removably mounted on said recipient with said post and tiers mounted on said recipient.

Typically, the recipient has a generally circular shape, said guard opening being generally circular and centrally located on said guard to mount on said recipient; and the guard has a substantially annular shape.

Typically, the guard defines a guard outer edge, said annular shape being generally tapered, said guard inner and outer edges being generally rounded in an axial direction opposite one another so as to have a substantially S-shaped cross section.

In one embodiment, the apparatus further includes a heating element connected to the recipient to heat the recipient within a predetermined temperature range for maintaining the flowable food media within said predetermined temperature range.

In one embodiment, the apparatus further includes a hollow stand for supporting said recipient thereon, said recipient including chamber walls to form a heating chamber therewith, said heating chamber surrounding said heating element and being located internally and spaced from said hollow stand.

In one embodiment, the conveyor mechanism includes an articulated worm screw.

Conveniently, the post securing means includes a lock mechanism to prevent rotation of said post relative to said recipient when mounted thereon.

According to still another aspect of the present invention, there is provided a fountain apparatus for use with a flowable food media, said apparatus comprising: a recipient for selectively receiving the flowable food media therein; a driving shaft sealably extending through said recipient; an elongated post defining generally opposed first and second longitudinal ends and a passageway extending longitudinally therebetween, said first longitudinal end mounting on said recipient so that said passageway is in fluid communication therewith; at least one tier mounted on said post; a conveyor mechanism operatively connecting to said post for conveying the flowable food media from said first longitudinal end toward said second longitudinal end through said passageway, said conveyor mechanism including a worm screw being removably connectable to said driving shaft via a screw connecting means at least partially protruding into said driving shaft.

According to yet another aspect of the present invention, there is provided a fountain apparatus for use with a flowable food media, said apparatus comprising: a recipient for selectively receiving the flowable food media therein; an elongated post defining generally opposed first and second longitudinal ends and a passageway extending longitudinally therebetween, said first longitudinal end mounting on said recipient so that said passageway is in fluid communication therewith, said post having at least one shoulder extending radially and outwardly therefrom; a conveyor mechanism operatively connecting to said post for conveying the flowable food media from said first longitudinal end toward said second longitudinal end through said passageway; a tier having a platform with an opening extending therethrough and defining a platform inner edge, said opening being configured and sized for being engageable by at least a longitudinal section of said post extending from said second longitudinal end to said at least one shoulder, at least a circumferential portion of said platform inner edge being adapted to be abuttingly supported by said shoulder.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, wherein:

FIG. 1 is a front view of a multi-tier fountain apparatus in accordance with an embodiment of the present invention, with chocolate flowing from the successive tiers and a plate of fruits;

FIG. 2 is a top perspective view of the embodiment of FIG. 1 in an assembled state which include a post extension and in dotted lines a recipient guard;

FIG. 3 is a simplified section view taken along line 3-3 of FIG. 2; FIG. 4 is a simplified top perspective view of one post section of FIG. 2, with one shoulder and one tier;

FIG. 4a is a simplified section view of the tier engaged on the shoulder of FIG. 4;

FIG. 4b is a simplified section view of another embodiment of a tier mounting mechanism with a shoulder machined on a ring connected to the post;

FIG. 5 is top perspective view showing the one-piece upper crown with the central grating of FIG. 2;

FIG. 6 is a simplified exploded perspective view of the connection of the auger onto the recipient of FIG. 2;

FIG. 7 is a simplified exploded perspective view of the connection of the post onto the recipient of FIG. 2;

FIG. 8 is a view similar to FIG. 2, showing another embodiment of a multi-tier fountain apparatus with a plurality of tier/post sections;

FIG. 9 is a simplified enlarged section view of another embodiment of a two-piece crown mounted on the upper end of a post;

FIG. 10 is a view similar to FIG. 4a, showing another embodiment of a multi-tier fountain apparatus with a tier mounting between two adjacent post sections; and

FIG. 11 is a view similar to FIG. 6, showing another embodiment of a multi-tier fountain apparatus with a plurality of tier/post sections.

### DETAILED DESCRIPTION OF THE PREFERRED EMBODIMENTS

With reference to the annexed drawings the preferred embodiments of the present invention will be herein described for indicative purpose and by no means as of limitation.

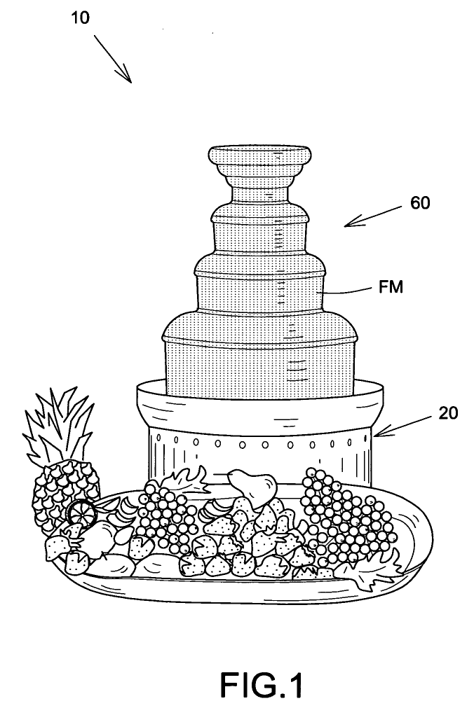

As shown in FIGS. 1 through 3, a fountain apparatus 10 for use with a flowable food media FM in accordance with an embodiment of the present invention includes a lower section 20 and an upper section 60. The lower section 20 includes a preferably cylindrical and hollow stand 22 and a recipient 24. Feet 26 are optionally secured underneath the stand 22 whilst the recipient 24 is secured on top of and covers the stand 22. The recipient 24 is a concave bowl or pan and spans a diameter RW and defines a concave cavity 28 or concave inner surface. Preferably, a drain hole 30 is provided in proximity to the most horizontal part of the interior cavity 28 of the recipient 24, or alternatively, the drain hole 30 is adjacent an apex region 29 of the inner surface 28. The drain hole 30 is furthermore connected to a drainpipe 32 closable by a stopper 33. A heating element 34 or electrical resistance is secured underneath and preferably in direct contact with the recipient 24 opposite the interior cavity 28, in an upper portion of the hollow stand 22. A heating chamber 36 is also preferably formed by a vertical wall 38 and a horizontal plate 40 boxing in, in conjunction with the recipient 24, the heating element 34. The heating chamber 36 stores the thermal capacitance produced by the heating element 34 and provides a barrier so as not to heat too much the stand 22 to prevent burns if skin comes in contact with the lower section 20 whilst the apparatus 10 is in operation. Apertures 42 are also preferably provided in the stand 22 adjacent the vertical positioning of the heating chamber 36 to further help dissipate the heat that filters through the heating chamber 36. The heating element 34 is connected via an electrical cord 44 to a source of electricity (not shown) and controlled by an on/off switch 46. An opened or “on” position is preferably indicated by a colored light indicator 48. A thermostat 50 is furthermore connected to the heating element 34 to control the temperature of the heating element 34 and a fuse 52 or circuit breaker offers an electrical protection.

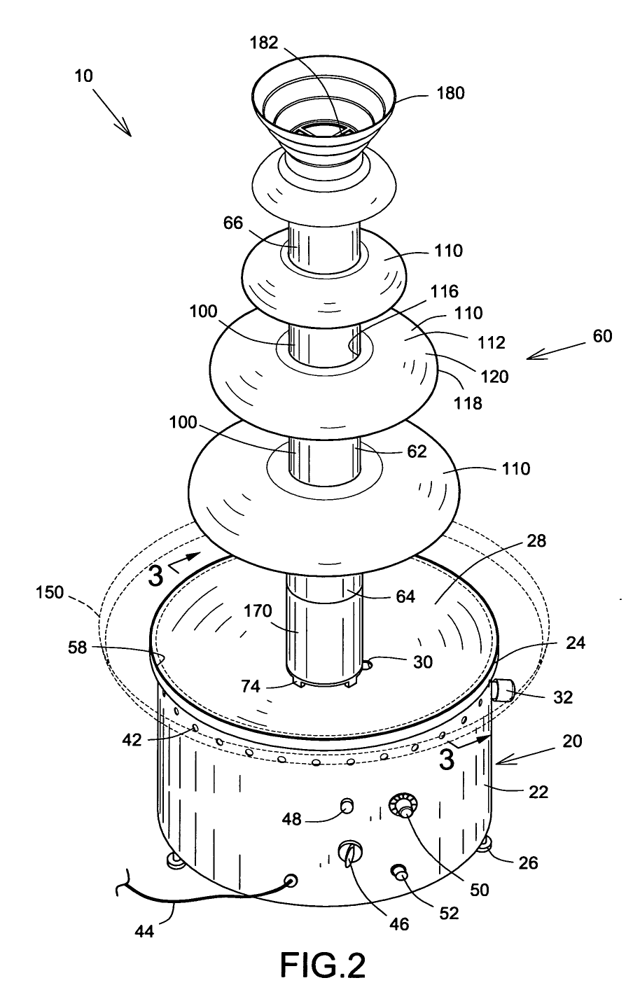

The upper section 60 includes a elongated post 62 which defines opposed first and second longitudinal ends 64 and 66 respectively and a passageway 68 extending longitudinally there between. The first longitudinal or lower end 64 defines an inside diameter 70, preferably continuous within the post 62, and a first outside diameter 72. The lower end 64 (or post extension 170 as shown in FIG. 2) is releasably and firmly mounted onto the recipient 24 via a post securing means 73 that substantially prevents the post 62 from wobbling or tilting when assembled thereon. The post securing means 73 typically includes a generally circular and hollow post mounting base 74 secured onto the interior cavity 28 of the recipient 24 adjacent the apex region 29. As shown with more details in FIG. 7, the post mounting base 74 extends outwardly from the interior cavity or inner surface 28 and includes a bottom section 76 and a top section 78. At least two stand-offs 80 secure the bottom section 76 onto the cavity 28 of the recipient 24. The stand-offs 80 are separated by inlet openings 82 there between. On each stand-off 80 is a stand-off shoulder (not shown) or alternatively a generally horizontal and circular flange shoulder 84 that separates the bottom and top sections 76, 78 of the post mounting base 74 and connects the stand-offs 80 together. An annular ring or circular flange 86 of outer diameter 88 generally forms the top section 78. The outer diameter 88 of the flange 86 is preferably slightly less than the inside diameter 70 of the lower end 64. The lower end 64 of the post 62 is then laid down onto the top section 76 of the post mounting base 74 until the lower end 64 comes in abutment contact with the flange shoulder 84 of the post mounting base 74. Accordingly, the flange 86 inwardly extends within the passageway 68 to abuttingly support the post 62 there against, by a length of at least about three millimetres (3 mm) or an eighth of an inch (⅛ in). The assembly preferably provides for an adjusted fitting, i.e. not too tight to enable manual assembly and disassembly, but tight enough so that the assembly stays in place when mounted and without gaps to allow for movements. As one skilled in the art will understand, when the post 62 is mounted on the post mounting base 74, the inlet openings 82 of the bottom section 76 provide for an opened fluid communication between the inner cavity 28 of the recipient 24 and the passageway 68 of the post 62. Furthermore, the outer diameter (not shown) of the bottom section 76 of the post mounting base 74 is preferably similar to the first outside diameter 72 of the lower end 64.

In order to prevent the rotation of the post 62 relative to the recipient 24 under the rotation of the worm screw 132 (detailed hereinafter) and the viscosity of the flowable food media FM, the post securing means 73 typically includes a lock mechanism 90. As shown in FIG. 7, the lock mechanism 90 typically includes a pin 92 press fitted into a corresponding through hole 92′ and radially mounted onto the post lower end 64 and slightly protruding inwardly thereof to be engagement with a corresponding notch 94 of the base flange 86. Although not illustrated herein, any other type of lock mechanism could be considered without departing from the scope of the present invention.

This post securing means 73 allows for the relatively easy attachment of the post 62 to the recipient 24 even tough the mounting base 74 is entirely submerged by the flowable food media FM and not visible to the operator; the lock mechanism 90 being simply engaged by rotating the post 62 when partially engaged into the mounting base 74.

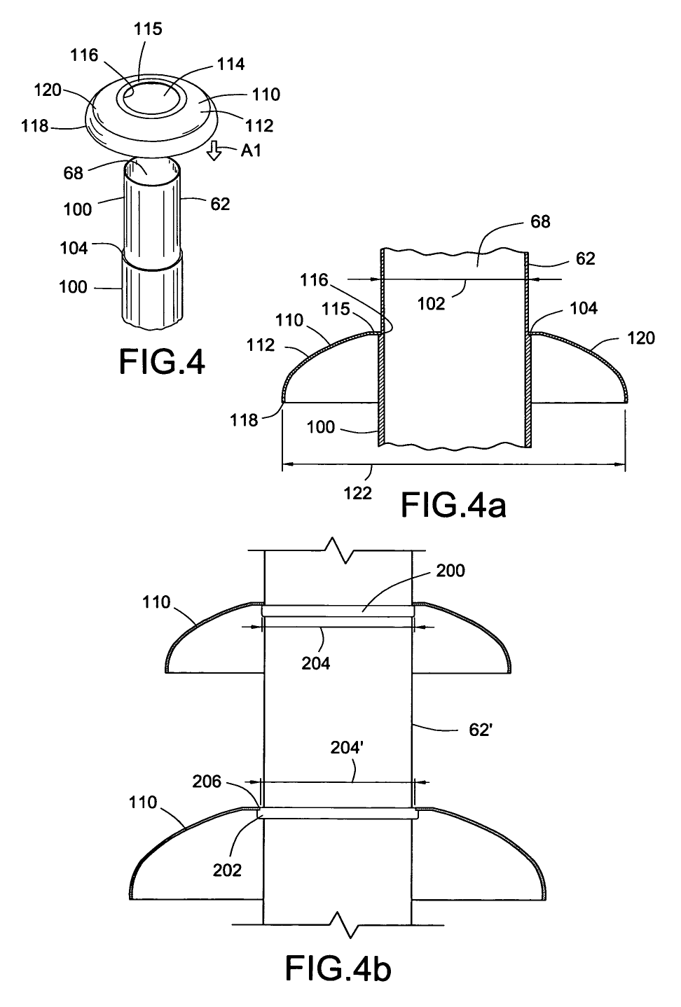

As seen more specifically on FIG. 2, the post 62 defines a series of post sections 100 extending between the first longitudinal or lower end 64 and the second longitudinal or upper end 66, in an end-to-end relationship relative to one another. Each post section 100, including the upper and lower ends 66 and 64 respectively, has a respective outer diameter 102 gradually increasing from the upper end 66 to the lower end 64. As shown also partially on FIGS. 4 and 4a, a series of shoulders 104, or steps, extending radially and outwardly from the center of the post 62 is formed at the successive interfaces of the sections 100 and ends 64, 66. Alternatively, at least two shoulder portions (not shown) extend radially, outwardly and partially circumferentially at the interfaces of one or all of the sections 100 and ends 64, 66. Typically, each shoulder 104 is substantially equally spaced from one another along the post 62.

As shown on FIGS. 2, 3 and 4, a truncated conical tier 110 consists of a platform 112 with an opening 114 extending through a generally inner flat region 115 of the platform 112. The platform 112 typically tapers radially and outwardly from the flat region 115 having an inner edge 116 towards an outer edge 118 in a direction going from the upper end 66 toward the lower end 64. Furthermore, the outer edge 118 of the platform forms a rounded radial outer end 120 extending axially away from the inner edge 116 so as to form the bowl shaped outer edge 118. Preferably, a series of tier 110 or platform 112 corresponds for each shoulder 104 of the post 62. As shown also on FIG. 4a, the opening 114 of each platform 112 is configured and sized to be engageable by at least a post section 100 and operatively relates to the respective outer diameter 102 so that each inner edge 116 of the tier 110 comes in abutment contact with a respective shoulder 104 of the post 62 to be supported thereon. Alternatively, at least a circumferential portion (not shown) of the platform 112 is in abutment contact with a shoulder 104 or with shoulder portions (not shown). Preferably, the outer diameter 122 of the platforms 112 gradually increases from the platform 112 adjacent the upper end 66 toward the platform 112 adjacent the lower end 64.

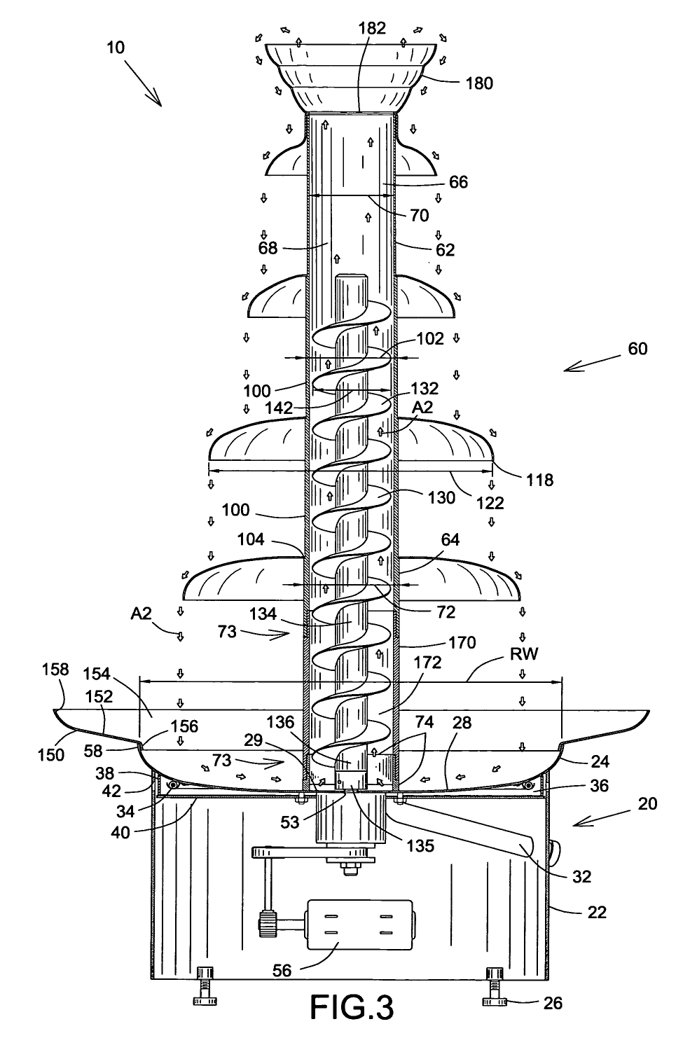

A conveyor mechanism 130 shown on FIG. 3 and partially on FIG. 7 includes a worm screw or auger 132 extending within the passageway 68 of the post 62. The screw 132 generally extends between half to three quarters of the height of the post 62, but could also extend up to the entire height. As more specifically shown on FIG. 6, an opening 53 in the apex region of the recipient enables the fitting of a driving shaft 54. A seal 55 provides the necessary hermeticity between the driving shaft 54 and the recipient 24. A motor 56 (shown in FIG. 3) connected to the driving shaft 54 and secured to the other elements of electrical system as it is well known in the art is secured inside the stand 22 and provides the necessary power to rotate the shaft 54. A screw connecting means 51 is typically provided for releasably connecting the screw 132 to the shaft 54. Accordingly, a diametrically extending slot 57 is preferably provided in the emerging portion of the driving shaft 54. The worm screw 132 includes a central shaft 134 with a first longitudinal end 136 connecting to the driving shaft 54, preferably through a shaft extension 135. The shaft extension 135 includes an axial bore 138 with a pin 140 diametrically extending therethrough and tightly fitted into corresponding through holes 143. One skilled in the art will understand that the pin 140 engages the slot 57 of the driving shaft 54 to secure the worm screw 132 within the passageway 68 of the post 62. Accordingly, the typically hollow shaft 134 is supported on a shoulder 141 of the shaft extension 135 and soldered thereto, the shaft extension 135 further prevents a flowable food media FM from going into the hollow shaft 134 as explained hereinbelow. Alternatively, it would obvious to one skilled in the art that the first end 136 of the shaft 134 could have the pin 140 and directly connect to the driving shaft 54. Other securing means between the worm screw 132, or its shaft extension 135, and driving shaft 54 exist in the art. An outer diameter 142 of the worm screw 132 is generally just slightly less than the inside diameter 70 of the elongated post 62 in order not to cause any frictional damage nor prevent the conveyor mechanism 130 from functioning properly.

As shown on FIGS. 2 and 3, a recipient splash guard 150 is preferably provided with a substantially annular shape 152. The splash guard 150 defines a centrally located generally circular opening 154 extending there through, a guard inner edge 156 and a guard outer edge 158. The recipient guard 150 is removably mounted on the recipient 24 adjacent a recipient outer edge 58. The inside diameter of the guard 150 at the guard inner edge 156 is slightly less than the recipient diameter RW of the recipient 24 to ensure a snuggle fit. Preferably, the annular shape 152 of the guard 150 is tapered and the inner and outer edges 156, 158 respectively are rounded in an axial direction opposite one another so as to have a substantially S-shaped cross section.

A post extension 170 is provided to vertically elevate the display of the fountain apparatus 10. The post extension 170 axially extends from the lower end 64 of the post 62 and is connectable to the post mounting base 74 of the recipient 24 in the same manner the lower end 64 may engage the same post mounting base 74 and as earlier described. The post extension 170 has an extension passageway 172 extending longitudinally there through. As one skilled in the art will understand, the extension passageway 172 is substantially an extension of the passageway 68 of the post 62 for a connection during operation with the conveyor mechanism 130. The post extension 170 preferably has the same inside diameter 70 as the post 62 and the same first outer diameter 72 as the lower end 64 of the post 62. An upper portion (not shown) of the post extension 170 is preferably similar to the top section 78 of the post mounting base 74 to ensure appropriate engagement with the lower end 64 of the post 62.

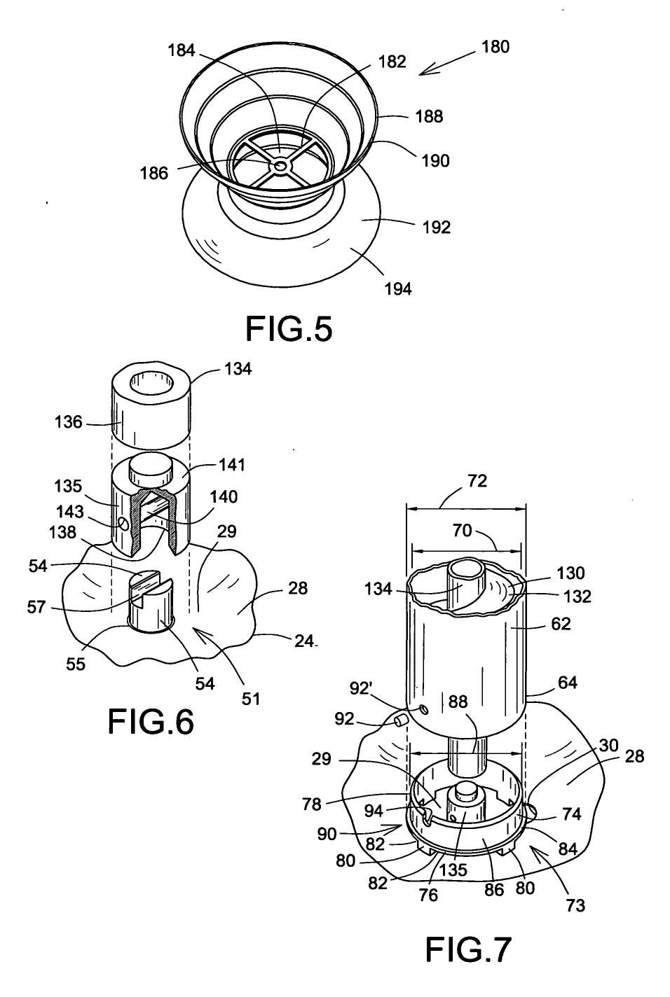

As shown in FIGS. 2, 3 and 5, an upper crown 180 is engageable on top of the upper end 64 of the post 62. The crown 180 includes a central grating 182 covering the post 62. The grating 182 generally has openings 184 for fluid communication with the passageway 68 of the post 62 and for creative use as explained further below. The openings 184 however should not be too large in order to prevent infants for example inserting a body part into the post 62 and to comply the Food and Drug Administration Regulations or the like. It should be notes however that the height at which the worm screw 132 compared to the height of the post 62 also helps ensuring no body harm can be caused by the apparatus. A centrally located opening 186 is preferably present to facilitate the manufacturing process of the upper crown 180. The crown 180 preferably includes an upper portion 188 formed of an upwardly and radially extending upper wall 190 and a lower portion 192 secured to the grating 182 and formed of a downwardly and radially extending lower wall 194 which in effect forms a first platform 112 of a first tier 110.

The material used to manufacture most parts of the apparatus 10 shall comply with the Food and Drug Administration Regulations. Accordingly, the recipient 24, the post 62, the tiers 110, conveyor mechanism 130, the recipient guard 150, the post extension 170 and most other parts are preferably manufactured using standard stainless steel. Although other manufacturing methods are possible, the splash guard 150, as well as the tiers 110, the recipient 24 and the crown 180, are typically made out of a single integral piece, preferably formed to the respective shape by spinning.

Mounting the apparatus 10 should be done with relative ease for someone skilled in the art. The stand 22 and recipient 24 are usually provided already assembled. The conveyor mechanism 130 is engaged next onto the driving shaft 54 as per the dotted lines of FIG. 6. The post extension 170 is mounted next on the post mounting base 74 is desired. The post 62 is then mounted on either the post extension 170 or on the post mounting base 74 as per the dotted lines of FIG. 7. The desired platforms 112 of the tiers 110 are engaged next one by one on the respective shoulder 104 of the post 62 following the arrow A1 of FIG. 4, starting with the larger tier 110 that goes in the lower position of the post 62. The second largest tier 110 is then placed in position, and successively for the other tiers 110. The result of each tier 110 in abutment contact with the shoulder 104 of the post 62 is shown in FIG. 4a. The upper crown 180 is then engaged on the upper end 66 of the post 62 and if desired, the recipient guard 150 is positioned onto the recipient 24. It should be noted that due to the opening 154 of the recipient guard 150 being larger that the outer diameter 122 of the larger tier 110, no problems are encountered when performing that assembly step. Obviously, the recipient guard 150 could be put in place earlier in the assembly process without causing any problems. Disassembling the apparatus 10 is done following the steps backward.

Operation

Once the apparatus 10 is assembled, the user (not shown) connects the electrical cord 44, turns on the switch 46 to activate the heating element 34. The thermostat can be used to ensure the desired heat is transmitted from the heating element 34 to the heating chamber 36 onto the inner surface 28 of the recipient 24. A desired flowable food media FM such as melted chocolate or the like is poured into the cavity 28 of the recipient 24. When required, the heating element 34 typically heats up the recipient 24 within a predetermined temperature range for maintaining the flowable food media FM within the predetermined temperature range. Then, by switching on the apparatus 10, the user also activated the motor 56 and thereby the driving shaft 54 and the worm screw 132 of the conveying mechanism 130.

As shown by the arrows A2 on FIG. 3, the melted chocolate that infiltrated the passageway 68 or extension passageway 172 via the inlet openings 82 of the post mounting base 74 rests on the lower threads of the screw 132 and is drawn upward by the rotation of the screw 132. The specific viscosity of the melted chocolate combined with the studied rotational speed of the screw 132 and the proximity of the screw threads with the post 62 within the passageway 68 enables the food media FM to ascend all along the post 62, from the lower end 64 to the upper end 66. The melted chocolate is furthermore sucked up by the conveyor mechanism from the outer parts of the recipient 24 all along the inner surface 28 towards the apex region 29 and through the inlet openings 82 to follow the same path as explained herein above. The melted chocolate then emerges at the top of the post 62, through the openings 184, 186 of the grating 182 and up the upper portion 188 of the upper crown 180. The pushing forces of the conveying mechanism 130 then stop acting on the melted chocolate and the gravity forces take the relay. As seen also by the arrows A2 and on FIG. 1, the melted chocolate FM cascades down the upper crown 180 and onto each of the following platform 112 of each tier 110, falling freely in-between the tiers. After the last and lower tier 110, the melted chocolate falls back into the recipient 24 to start another cycle.

It should be understood that the chocolate slightly loses a bit of calorific value while going up the extension passageway 172 and coming down the tiers 110, but gains it back in the heated recipient 24 before starting a new cycle. Furthermore, chunks of chocolate could easily be added in the melted chocolate FM for example. The chunks might not go through the inlet openings 82, but continuous suction towards the passageway 68 or extension passageway 172 combined with the warmth of the food media FM in the recipient 24 will slowly melt those chunks down. The smaller chunks can easily follow the same cycle as presented before, provided the openings 184 are large enough, and offer further amusing entertaining to the guests of the user. Pieces of fruits such as blueberries or the like can be thrown into the recipient 24 or into the passageway from the upper end 66 for various entertaining reasons, although it should be understood that fruits will not melt down. When the chocolate is cascading down as shown in FIG. 1, a user can easily put a piece of fruit on a fork and bring it under the curtain of falling melted chocolate in-between the tiers 110 for enrobing the fruit with melted chocolate prior to consumption. The large area covered by the recipient splash guard 150 prevents drippings of chocolate to fall on a table supporting the apparatus 10, although the diameter RW of the recipient already provide some protection in that regards. If desired and necessary, melted chocolate can be added into the recipient 24. Hard pieces of chocolate could alternatively be put into the recipient 24, but some time would be needed prior to most of the chocolate being melted for operation. Once the apparatus 10 is not needed, the switch 46 is turned off cleaning the apparatus 10 can begin. Some parts can easily be removed for separate washing, whilst the drainpipe stopper 33 is removed to allow the melted chocolate left in the recipient 24 to exit there from through the drainpipe 32. Water or soapy water can be added into the recipient 24 there after to continue the cleaning (washing and rinsing) process.

Alternatives

With reference to FIG. 4b, there is shown a post 62′ having a uniform external diameter with a plurality of rings 200, 202 mounted thereon, preferably soldered, screwed and using screw fasteners or the like, to abuttingly support the respective tier 110 thereon. Typically, the first ring 200 provides the shoulder to support the upper tier 110 while allowing passage of the lower tiers 110, having openings 114 with a diameter larger than or slightly larger than (for the second tier, and illustrated with reference numeral 204′) the outside diameter 204 of the first ring 200, to be dropped further down. The following ring 202 includes a shoulder 206 configured and sized to support the corresponding second tier 110 while allowing passage of the lower successive tiers 110; and so on for the lower rings and tiers.

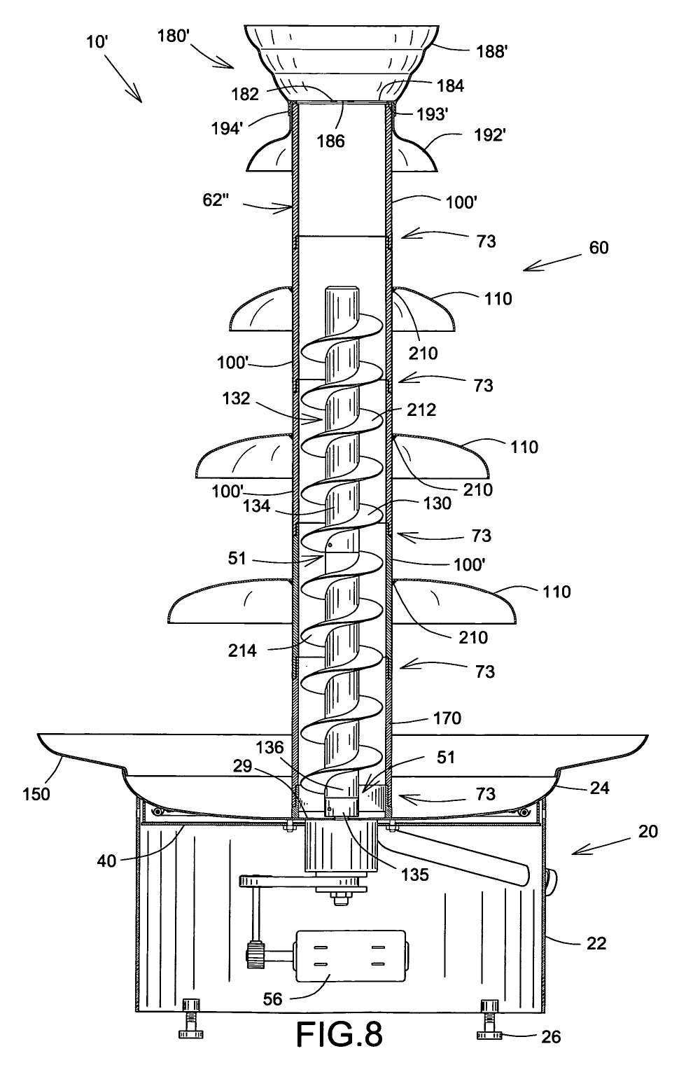

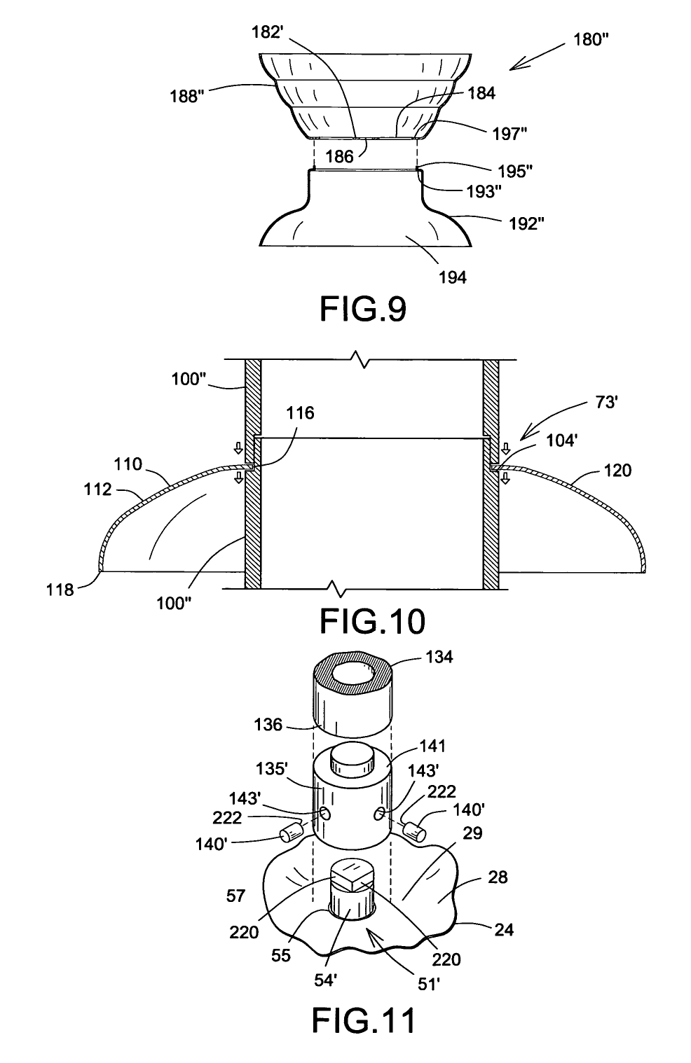

Now referring more specifically to FIG. 8, there is shown another embodiment of a multi-tier fountain apparatus 10′ having its post 62″ made out of a plurality of successive tier/post sections 100′ connecting to each other via a post securing means 73, similar to the one shown in FIGS. 2, 3 and 7, such that the size of the apparatus 10′ and the number of tiers 110 may easily vary according the to specific needs of each user. In this configuration, each tier 110 is typically soldered onto its respective post section 100′, with a solder line 210 or spot welds preferably at a generally hidden location under each tier 110. And the inside diameter of the post 62″ remains essentially constant, at least along the section receiving the worm screw 132′ therein.

In order to enable different apparatus heights using the tier/post sections 100′, the worm screw 132′ can be made out of a plurality of screw sections 212, 214 connecting to one another with a screw connecting means 51 similar to the one of FIG. 6. The use of at least two screw sections 212, 214 provides for an articulated screw 132′ that is allowed to follow the any linear deformation that could occur to the post 62′, the latter being made out of either a single piece or a plurality of post sections 100′.

Also shown in FIG. 8 is a two-piece crown 180′ with the lower section 192′ having an inner flange 193′ to abuttingly engage the upper end 66 of the post 62″, or even be soldered thereto, and an upper section 188′ having a shorter lower flange or wall 194′ axially extending therefrom to enclose the upper flange 193′ of the lower section 192′. The upper section 188′ typically includes the grating 182 with openings 184, 186.

Now referring more specifically to FIG. 8, there is shown another embodiment of a two-piece crown 180″ in which the inner flange 193″ of the lower section 192″ includes upwardly and axially oriented protruding pins 195″ or the like adapted to engage corresponding through holes 197″ of the grating 182′ of the upper section 188″.

With reference to FIG. 10, there is shown an alternate way of attaching the different tiers 110 at the intersections between two adjacent post sections 100″. Each tier 110 has its inner edge 116 abuttingly supported by a shoulder 104′ of a subjacent post section 100″, and clamped or sandwiched between the two post sections 100″ at the post securing means 73′ such that it is secured there between.

With reference to FIG. 11, there is shown an alternate screw connecting means 51′ in which the driving shaft 54′ includes at least one (two 90° from each other shown in FIG. 11) flat surface 220 facing radially outwardly from at its upper end. The surface 220 is adapted to be frictionally engaged by the free end 222 of a corresponding pin 140′ protruding radially inwardly and press fitted into a through hole 143′ of the screw shaft 134 (or shaft extension 135′) when the screw shaft 134 is properly engaged into the driving shaft 54′. Although not illustrated herein, one, three, four or even more pins 140′ and corresponding surfaces 220 could be considered without departing from the scope of the present invention. Similarly, one could consider to have a quantity of pins 140′ less than the quantity of corresponding surfaces 220.

Although stainless steel type materials are preferred for most components such as the tiers 110, the post 62 (and sections 100, 100′, 100″), the post extension 170, the screw 132 (and sections), the crown 180, 180′, 180″ and the splash guard 150, it would be obvious to one skilled in the art that any other types of FDA approved materials such as some plastics could be considered for any of the components without departing from the scope of the present invention.

Although the present apparatus has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. A fountain apparatus for use with a flowable food media, said apparatus comprising:
a recipient for selectively receiving the flowable food media therein;
an elongated post defining generally opposed first and second longitudinal ends and a passageway extending longitudinally therebetween, said first longitudinal end mounting on said recipient so that said passageway is in fluid communication therewith, said post having a plurality of post longitudinal sections extending in an end-to-end relationship relative to one another and releasably and abuttingly supporting one another;
a conveyor mechanism operatively connecting to said post for conveying the flowable food media from said first longitudinal end toward said second longitudinal end through said passageway;
at least one tier mounted on one of said post sections.

2. The apparatus of claim 1, wherein at least one of said post sections permanently supports a said tier thereon.

3. The apparatus of claim 2, wherein said at least one of said post sections has two opposed longitudinal section ends, said tier being permanently supported thereon at substantially half way between said section ends.

4. The apparatus of claim 1, wherein at least one of said post sections includes a ring connected thereto for abuttingly supporting a said tier thereon.

5. The apparatus of claim 1, further including a post securing means removably connecting adjacent said post sections to one another.

6. The apparatus of claim 5, wherein said post securing means allow said tier to be abuttingly supported thereon in-between said adjacent said post sections.

7. The apparatus of claim 6, wherein said tier has an inner edge defining an opening extending therethrough, said inner edge being abuttingly supported in sandwich configuration in-between said adjacent said post sections.

8. The apparatus of claim 5, wherein said post securing means removably connects said post section forming said post first end to said recipient.

9. The apparatus of claim 8, wherein said post securing means includes a lock mechanism to block rotation of said adjacent said post sections relative to each other when connected to one another.

10. The apparatus of claim 9, wherein said post securing means includes a flange formed at a longitudinal end of one of said adjacent said post sections slidably engaging in abutting engagement a corresponding mating flange formed at a longitudinal end of a corresponding said adjacent said post section.

11. The apparatus of claim 10, wherein said flange extends axially outwardly from said longitudinal end of said adjacent said post section and partially forms said passageway, said corresponding mating flange extending axially outwardly from said longitudinal end of said corresponding said adjacent post section and partially forming an outer wall surface of said post.

12. The apparatus of claim 10, wherein said lock mechanism includes a key extending radially from one of said flanges and a corresponding groove extending radially into the other one of said flanges, said key, when engaged into said groove, blocking rotation of said adjacent said post sections relative to one another.

13. The apparatus of claim 1, wherein said conveyor mechanism includes a worm screw removably connected to a driving shaft via a worm screw connecting means, said driving shaft sealably extending through an opening of said recipient, said worm screw axially mounting into said passageway for conveying the flowable food media from said first longitudinal end toward said second longitudinal end.

14. The apparatus of claim 13, wherein said conveyor mechanism includes a screw connecting means for removably and operatively connecting said worm screw to said driving shaft.

15. The apparatus of claim 14, wherein said worm screw includes a plurality of screw longitudinal sections extending in an end-to-end relationship relative to one another and removably, abuttingly and operatively supporting one another, said screw connecting means further removably and operatively connecting adjacent said screw sections to one another.

16. The apparatus of claim 15, wherein said screw connecting means screw connecting means includes a protrusion at least partially and operatively engaging a corresponding recess.

17. The apparatus of claim 16, wherein said protrusion and said recess mesh with one another in a generally radial direction.

18. The apparatus of claim 17, wherein said protrusion extends inwardly from a central shaft of one of said adjacent screw sections and said recess is a generally planar wall formed within a central shaft of the other one of said adjacent screw sections and generally perpendicular to said radial direction.

19. The apparatus of claim 18, wherein said central shaft of the other one of said adjacent screw sections includes a plurality of generally planar walls formed therein and selectively meshable with said radial protrusion.

20. The apparatus of claim 15, wherein said screw connecting means screw connecting means includes a plurality of protrusions at least partially engaging a plurality of corresponding recesses.

21. The apparatus of claim 1, further including a two-piece crown removably connected to said post second end, said crown having a passageway extending longitudinally therethrough and being in fluid communication with said post passageway.

22. The apparatus of claim 21, wherein said two-piece crown includes a first piece removably supported by said post second end and a second piece removably mounting on said first piece, said crown further including a lock mechanism to prevent said first and second pieces from rotating relative to one another.

23. The apparatus of claim 13, wherein said worm screw has a central shaft with a shaft first longitudinal end connectable to said driving shaft, said worm screw connecting means including an axial bore of said shaft first end with a pin diametrically extending therethrough, said pin removably engaging a corresponding diametrically extending slot of said driving shaft.

24. The apparatus of claim 13, wherein said worm screw has a central shaft with a shaft first longitudinal end connected to said driving shaft through a shaft extension, said worm screw connecting means including an axial bore of said shaft extension with a pin diametrically extending therethrough, said pin removably engaging a corresponding diametrically extending slot of said driving shaft.

25. The apparatus of claim 1, wherein said recipient defines a recipient outer edge, said recipient including a recipient guard mounting on said recipient adjacent said recipient outer edge.

26. The apparatus of claim 25, wherein said recipient guard has a guard opening extending therethrough, said guard opening defining a guard inner edge removably connectable to said recipient outer edge.

27. The apparatus of claim 26, wherein said guard opening is sized to enable said guard to be removably mounted on said recipient with said post and tiers mounted on said recipient.

28. The apparatus of claim 26, wherein said recipient has a generally circular shape, said guard opening being generally circular and centrally located on said guard to mount on said recipient.

29. The apparatus of claim 25, wherein said guard has a substantially annular shape.

30. The apparatus of claim 29, wherein said guard defines a guard outer edge, said annular shape being generally tapered, said guard inner and outer edges being generally rounded in an axial direction opposite one another so as to have a substantially S-shaped cross section.

31. The apparatus of claim 1, further including a heating element connected to the recipient to heat the recipient within a predetermined temperature range for maintaining the flowable food media within said predetermined temperature range.

32. The apparatus of claim 1, further including a hollow stand for supporting said recipient thereon, said recipient including chamber walls to form a heating chamber therewith, said heating chamber surrounding said heating element and being located internally and spaced from said hollow stand.

33. A fountain apparatus for use with a flowable food media, said apparatus comprising:
a recipient for selectively receiving the flowable food media therein;
an elongated post defining generally opposed first and second longitudinal ends and a passageway extending longitudinally therebetween;
a conveyor mechanism operatively connecting to said post for conveying the flowable food media from said first longitudinal end toward said second longitudinal end through said passageway; and
a post securing means for releasably mounting said first longitudinal end on said recipient, said post securing means including a post mounting base having a plurality of standoffs connected to said recipient, said standoffs being spaced apart form one another and defining inlet openings therebetween to allow said passageway to be in fluid communication with said recipient, said post mounting base including a flange interconnecting said standoffs to one another, said post mounting base having a shoulder to abuttingly support said post thereon along with said flange being inwardly extendable within said passageway to abuttingly support said post thereagainst.

34. The apparatus of claim 33, further comprising a post extension axially extending said post first longitudinal end, said post extension being connectable to said recipient via said post securing means, said post extension having an extension passageway extending longitudinally therethrough, said extension passageway being substantially an extension of said passageway for operative connection with said conveyor mechanism to convey the flowable food media therethrough between said recipient and said passageway.

35. A fountain apparatus for use with a flowable food media, said apparatus comprising:
a recipient for selectively receiving the flowable food media therein;
a driving shaft sealably extending through said recipient;
an elongated post defining generally opposed first and second longitudinal ends and a passageway extending longitudinally therebetween, said first longitudinal end mounting on said recipient so that said passageway is in fluid communication therewith;
at least one tier mounted on said post; and
a conveyor mechanism operatively connecting to said post for conveying the flowable food media from said first longitudinal end toward said second longitudinal end through said passageway, said conveyor mechanism including a worm screw being removably connectable to said driving shaft via a screw connecting means at least partially protruding into said driving shaft.

36. A fountain apparatus for use with a flowable food media, said apparatus comprising:
a recipient for selectively receiving the flowable food media therein;
an elongated post defining generally opposed first and second longitudinal ends and a passageway extending longitudinally therebetween, said first longitudinal end mounting on said recipient so that said passageway is in fluid communication therewith, said post having at least one shoulder extending radially and outwardly therefrom;
a conveyor mechanism operatively connecting to said post for conveying the flowable food media from said first longitudinal end toward said second longitudinal end through said passageway; and
a tier having a platform with an opening extending therethrough and defining a platform inner edge, said opening being configured and sized for being engageable by at least a longitudinal section of said post extending from said second longitudinal end to said at least one shoulder, at least a circumferential portion of said platform inner edge being adapted to be abuttingly supported by said shoulder.
